(19) United States
(12) Patent Application Publication
(10) Pub. No.: US 2026/0061713 A1
(43) Pub. Date: Mar. 5, 2026

(54) CURING MOLD AND METHOD FOR CURING A GREEN TIRE

(71) Applicant: COMPAGNIE GENERALE DES ETABLISSEMENTS MICHELIN, Clermont-Ferrand (FR)

(72) Inventors: LUDOVIC JOKSCH, Clermont-Ferrand (FR); FRANCOIS ROUYET, Clermont-Ferrand (FR)

(21) Appl. No.: 19/101,007

(22) PCT Filed: Jul. 24, 2023
(86) PCT No.: PCT/EP2023/070409

§ 371 Date: Feb. 4, 2025

(30) Foreign Application Priority Data
Aug. 5, 2022 (FR) FR2208129

(51) Int. Cl. B29D 30/06

(52) U.S. Cl. CPC B29D 30/0606; B29D 2030/0607

(57) ABSTRACT

A mold (10) for curing a tire comprises: an upper shell (16a) for molding a tire sidewall, a lower shell (16b) for molding a tire sidewall, and a crown ring (20) of circumferential segments for molding a tire tread, each segment comprising an upper segment part (20a) suitable for being axially separated from a lower segment part (20b), the curing mold being suitable for interacting with means for actuating a radial movement of all of the segment parts simultaneously. Each lower segment part (20b) comprises a device (100) for holding the lower segment part (20b) in a radial position between a closed position of the mold and an open position thereof, the elements of the holding device (100) belonging to the lower segment part and to the lower shell (16b).

The invention relates to the manufacture of tyres and in particular to the moulds and methods for curing or vulcanizing a green tyre. It particularly relates to the manufacture of tyres comprising tread patterns that extend onto the sidewalls, such as those used for all-terrain (or off-road) vehicles.

The manufacture of a tyre comprises a curing step during which a green tyre blank is vulcanized and moulded in order to obtain a tyre having desired mechanical characteristics, geometry and appearance. Curing is performed in a tyre curing mould comprising upper and lower moulding assemblies capable of moving axially relative to each other. The moulding assemblies comprise moulding elements that together define an internal tyre-moulding surface. A mould thus mainly comprises two shells for moulding the sidewalls of the tyre and two rings for moulding the beads of the tyre that are situated axially on either side of a crown ring comprising a plurality of circumferential segments for moulding the tread of the tyre. Such a curing mould is arranged inside a curing press comprising inter alia mechanisms that make it possible to open and close the curing mould on a green tyre and to open it in order to remove the vulcanized tyre and insert a new green tyre.

WO 2014/044713 in the name of the applicant describes such a curing mould for a tyre mainly comprising an upper shell for moulding the sidewalls of a tyre that is capable of moving with the upper plate of the press, and a lower shell for moulding the sidewalls of the tyre that is fixed and held by the lower plate of the press. The mould also comprises a crown ring of circumferential segments for moulding the tread of the tyre that are capable of moving radially between an open position and a closed position of the mould. Each segment is connected to the upper plate of the press on which the upper shell is fixed so that it can move axially with it, while also being capable of moving radially relative thereto. Each segment is thus capable of sliding radially relative to the upper shell and capable of sliding axially and radially relative to the lower shell. While it operates satisfactorily, it has been observed that such a mould is not suitable for moulding tyres on which the tread pattern of the tread extends onto the sidewalls, as the radial retraction of the segments of such a mould is not sufficient to allow the removal of the vulcanized tyre.

In addition, KR20140018710A discloses a curing mould the mechanism of which is similar to that described in the preceding document, but in which the crown ring of circumferential segments has been divided into two parts, upper and lower, by means of a horizontal plane passing through the meridian of the tyre in order to facilitate the insertion of the green tyre before curing and the removal of the cured tyre. The two crown rings of segments are radially retracted when an actuator axially translates the upper shell, but only the upper crown ring of segments lifts with the upper shell, while the lower crown ring of segments remains in contact with the lower shell. A guide finger, which protrudes at the radial interface of each upper segment in the open position of the mould, interacts with an orifice of the facing lower segment when the mould is closed. The guide finger pushes a spring-mounted rod situated in the facing lower segment, which rod is provided in order to guide the radial translation of the lower segment. Although it allows greater radial retraction than the segments of the preceding document, modifications must however be made to the curing press, more particularly to the lower plate thereof or to the tools for actuating the mould, so that they can receive the mould according to said document.

There is still a need to be able to use the same curing press and the same tools for actuating the mould, without modifications, for different types of tyres comprising different types of tread pattern, and therefore a need to be able to receive different curing moulds.

One aim of the invention is to overcome the drawbacks of the aforementioned documents and therefore facilitate the moulding and demoulding of tyres on which the tread pattern of the tread extends onto the sidewalls. Another aim of the invention is to improve the appearance of the moulded tyre.

This aim is achieved by the invention, which proposes a curing mould for a tyre comprising:
an upper shell for moulding a tyre sidewall,
a lower shell for moulding a tyre sidewall,
a crown ring of circumferential segments for moulding a tyre tread, each segment comprising an upper segment part suitable for being axially separated from a lower segment part, the curing mould being suitable for interacting with
means for actuating a radial movement of all of the segment parts simultaneously and an axial movement of the upper part of each segment relative to the lower part of the same segment during the operations to open and close the mould, characterized in that each lower segment part comprises a device for holding the lower segment part in a radial position between a closed position of the mould and an open position thereof, the elements of the holding device belonging to the lower segment part and to the lower shell.

The curing mould of the invention comprises a crown ring of circumferential segments that forms a closed ring in the closed position of the mould, the crown ring of circumferential segments being cut along a horizontal radial plane so that the upper and lower parts of the segments of the crown ring can be separated from each other axially and circumferentially during the opening of the mould. This already allows greater opening of the moulding cavity, which makes it easier to remove a tyre on which the tread patterns of the tread extend onto the sidewalls.

The invention proposes a device produced so as to make it possible to hold the lower part of each segment in a radial position in order to limit the risk of relative movement between the upper and lower parts of the segments during the movement thereof to open and close the mould. In addition, such a device for holding the lower segment part in position prevents any accidental displacement thereof that might occur when the mould is open (for example a falling object, action by an operator in the press, etc.). The lower segment part is therefore held in position radially and can interact correctly with the upper segment part during the movement thereof to open and close the mould. Holding the lower segment part in position is given to mean that it is held in a stable position that it maintains provided that a predetermined force has not been imparted to it so that it leaves this holding position.

Also according to the invention, since all of the elements of the holding device belong to the lower part of the segment and to the lower shell, the mould of the invention can be installed on any suitable press, without making modifications to the elements, for example the plates, thereof.

In addition, since the holding device is connected to each lower segment part, this solution can be applied to any type of mould regardless of the number of segments or their positioning in the mould.

The holding device can be produced so as to make it possible to hold the lower segment part in an axial position. This makes it possible to hold the lower segment part in a stable axial position, as well as holding it in a stable radial position, in order to ensure satisfactory operation of the mould without damaging the tyre, for example when the mould is opened in order to remove the cured tyre and the tyre has a tendency to adhere to the walls of the curing mould.

Said holding device can comprise a slider extending in a radial direction that interacts with a pusher produced so as to exert a radial force on the slider during the radial movement of the lower segment part between an open position and a closed position of the mould. Still according to the invention, the pusher exerting an axial force in the direction of the slider thus makes it possible to also hold the lower segment part in a stable axial position in its two end positions: a first radially inner position when the mould is closed and a second radially outer position when the mould is open.

In a first embodiment of the invention, the slider can be capable of moving with the lower segment part and said pusher can be fixed on the lower shell by means of a soleplate.

The slider can comprise a roller that is able to interact with two notches arranged on either side of the pusher in the soleplate during the radial movement of the lower segment part.

In a second embodiment of the invention, the slider can be fixed on the lower shell and the pusher can be capable of moving with the lower segment part.

The slider can comprise two notches that are able to interact with a ball of the pusher during the radial movement of the lower segment part.

Said pusher can comprise a return spring.

Said return spring can be calibrated so that it is able to hold the lower segment part in a predefined position when the force exerted on the pusher is less than the force that it undergoes when the mould is closed.

The slider can have a cross-section in the shape of a dovetail. This dovetail shape makes it possible to satisfactorily guide the radial translation of the lower segment part and hold it in an axial position, especially in the case of a tacky composition or complex tread patterns of the tyre, which thus has a tendency to adhere to the inner walls of the moulding parts of the mould.

The invention also relates to a method for moulding a tyre using a mould comprising
an upper shell for moulding a tyre sidewall,
a lower shell for moulding a tyre sidewall,
a crown ring of circumferential segments for moulding a tyre tread, each segment comprising an upper segment part suitable for being axially separated from a lower segment part, the mould being suitable for interacting with
means for actuating a radial movement of all of the segment parts simultaneously and an axial movement of the upper part of each segment relative to the lower part of the same segment during the operations to open and close the mould, the method including a step of removing the tyre at the end of curing when all of the segments are simultaneously moved radially outwards and when the upper part of each segment is moved axially upwards, the lower part of the segment being caused to switch from a first radially inner holding position to a second radially outer holding position.

The moulding method of the invention can comprise a step of closing the empty mould followed by a step of opening the mould without radial retraction of the segments in order to insert a new green tyre into the mould.

The moulding method of the invention can comprise a step of closing the mould axially only on the green tyre inserted into the mould.

The invention will be better understood from the remainder of the description, which is based on the following figures:

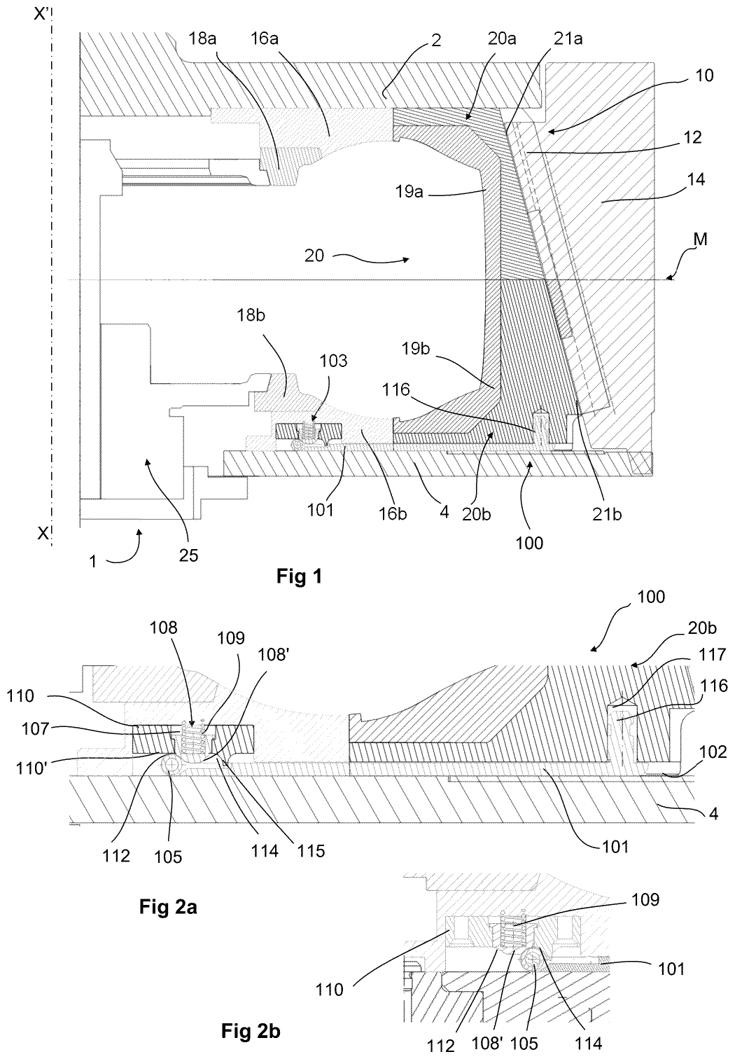

FIG. 1 is a radial cross-sectional view of a curing mould according to a first embodiment of the invention;

FIG. 2a is a radial cross-sectional view on a larger scale of the lower part of the mould in FIG. 1 illustrated in a closed position, and FIG. 2b is a detail view of the device for holding the segment in position in FIG. 2a, the mould being in an open position;

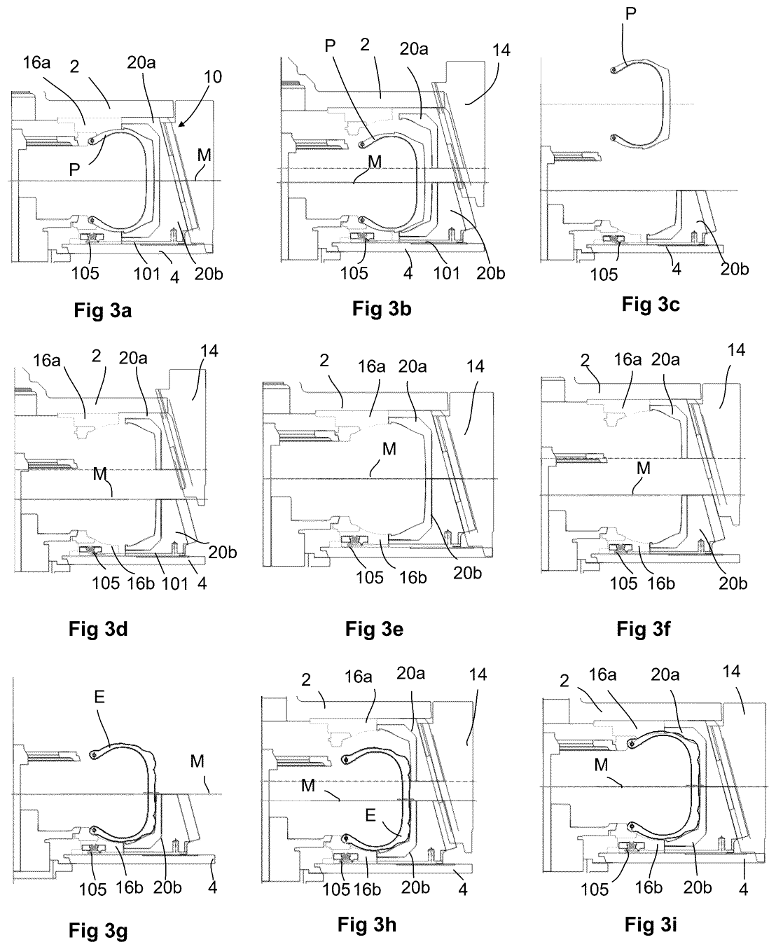

FIGS. 3a to 3i are simplified radial cross-sectional views illustrating the mould in FIG. 1 in different operating positions;

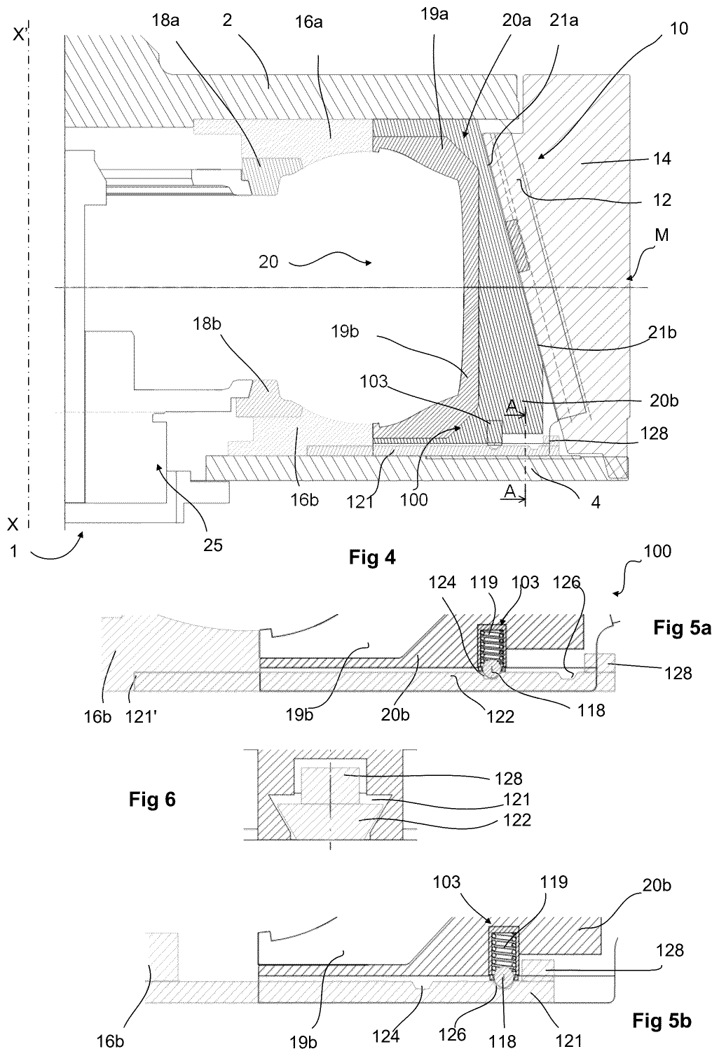

FIG. 4 is a radial cross-sectional view of a curing mould according to a second embodiment of the invention;

FIG. 5a is a radial cross-sectional view on a larger scale of the lower part of the mould in FIG. 4 illustrated in a closed position and FIG. 5b is a detail view of the device for holding the segment in position in FIG. 5a, the mould being in an open position;

FIG. 6 is a cross-sectional view on a larger scale along the plane A-A;

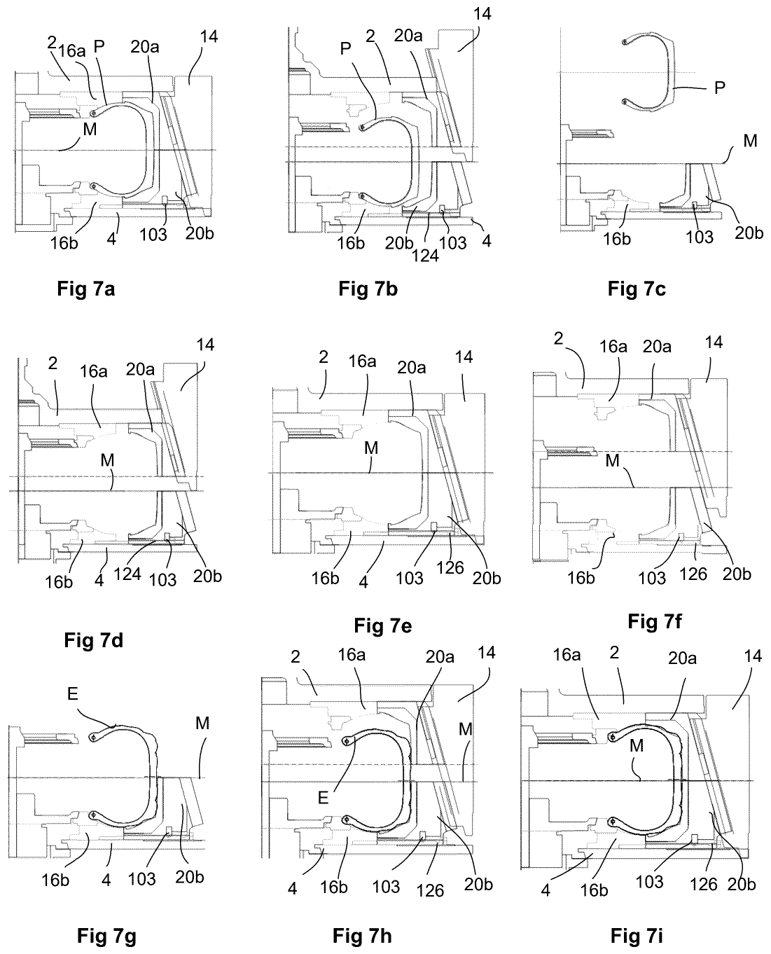

FIGS. 7a to 7i are simplified radial cross-sectional views illustrating the mould in FIG. 4 in different operating positions.

In the various figures, elements that are identical or similar have the same reference signs. Their description is therefore not systematically repeated.

FIG. 1 shows a mould 10 for curing a green tyre according to a first embodiment of the invention. The curing mould 10 is intended to be inserted between the upper 2 and lower 4 plates of a curing press 1. A curing press comprises a frame forming a base of the mould, assumed to be stationary and fixed to the ground. The press also comprises means (for example hydraulic cylinders) for guiding and actuating the mechanisms for opening and closing the mould, together with an installation making it possible to supply the mould with the curing conditions (in terms of the pressure and temperature of the heat-transfer fluid) necessary for vulcanizing the tyre.

The mould 10 for curing a green tyre comprises an upper moulding assembly and a lower moulding assembly, each moulding assembly comprising an upper shell 16a and a lower shell 16b respectively for moulding a sidewall of the tyre, and an upper ring 18a and a lower ring 18b respectively for moulding a bead of the tyre, together with a crown ring 20 of circumferential segments for moulding the tread of the tyre. In the example illustrated in the figures, the mould is of the “container” type, wherein the upper shell 16a is caused to slide axially with the upper plate 2 of the press, the lower shell 16b is rigidly fastened to the lower plate 4 of the press, and the circumferential segments are caused to move in a radial direction during the opening and closing of the mould.

The curing mould 10 substantially exhibits symmetry of revolution about a central axis X-X′. The central axis extends vertically. In the remainder of the description, “axial” or “axially” refers to a direction or a movement parallel to the central axis, and “radial” or “radially” refers to a direction or a movement perpendicular to the central axis X-X′. A circumferential direction is a direction tangent to the radial direction and corresponds to the circumferential direction of the tyre.

The circumferential segments of the crown ring 20 are arranged side by side in a circumferential direction and each segment of the crown ring is divided into two parts, upper and lower, preferably by a radial plane that is a median plane M in the example shown, that is, a plane that passes equidistant from the beads of the tyre, and therefore from the moulding rings 18a, 18b. More specifically, each segment comprises an upper segment part 20a and a lower segment part 20b, the upper 20a and lower 20b parts being situated on either side of the plane M so that they come into contact when the mould is closed and move away from each other when the mould is opened, as will be explained below. Each segment part comprises a lining for moulding the tread patterns of the tyre held by a segment support. The upper segment part 20a thus comprises a lining 19a that extends from the interface with the lower part 20b to the interface with the upper shell 16a. Similarly, the lower segment part 20b comprises a lining 19b that extends from the interface with the upper part 20a to the interface with the lower shell 16b. As can be seen in FIG. 1, the linings 19a, 19b extend beyond the tread and are intended to mould a tyre on which the tread patterns of the tread extend onto the sidewalls.

The radially outer surfaces 21a and 21b of the supports of the linings of the upper 20a and lower 20b segment parts are conical, and have the same inclination extending downwards and radially outwards.

The press further comprises a conical ring 14 the radially inner surface 14a of which is inclined radially downwards and has the same inclination as the radially outer surfaces 21a and 21b. The conical ring is connected to an actuator of the curing press, for example a hydraulic cylinder, which allows it to perform an axial movement upwards and downwards. During the closing of the mould, the conical ring 14 moves downwards, it is positioned on the crown ring 20 of segments, it brings the segments radially inside the mould, and it applies a force to the segments to keep the assembly closed during curing when the temperature inside the moulding cavity increases. The conical ring 14 comprises a plurality of sliders 12 each rigidly fastened to the conical ring, each slider being intended to slide in a rail of a corresponding segment of the crown ring 20. Stops situated between one end of the slider 12 and a notch in the outer surface 21a of each segment make it possible to limit the stroke of the radial retraction of the segments during the upward movement of the conical ring to open the mould. In this embodiment, the conical ring 14, the sliders 12 and the elements for connecting them to the segments of the mould and to the upper plate of the press are as described in WO 2014/044713.

The upper plate 2 of the press is connected to another actuator, such as a hydraulic cylinder, which allows it to perform an axial movement upwards and downwards during the operations to close and open the mould, as will be explained below.

In the open position of the mould, the conical ring 14 and the upper moulding parts, namely the upper segment parts 20a, the upper shells 16a, and the upper moulding ring 18a rigidly connected to the upper plate 2 of the press are moved axially upwards so that the clear the moulding cavity so that the cured tyre can be removed and a new green tyre inserted. During the closing of the mould, the upper plate moves downwards and, the upper segment parts 20a being retracted radially outwards, the conical ring 14 moves downwards to close the curing cavity and therefore the mould with a view to curing. The heat-transfer fluid arrives inside the moulding cavity from a device 25 situated in the central part of the curing cavity, comprising for example a curing bladder that presses the green tyre against the inner parts of the mould during curing.

According to the invention, each lower segment part 20b is provided with a device 100 for holding the lower segment part 20b in a radial position between a closed position of the mould and an open position of the mould.

In the first embodiment, which can be seen most clearly in FIGS. 1, 2a and 2b, the elements of the holding device 100 belong to the lower segment part 20b and to the lower shell 16b. More specifically, the holding device 100 comprises a slider 101 suitable for moving in a cavity 102, having an elongated shape extending in the radial direction and made at the base of the lower segment part 20b, which slider interacts with a pusher 108 arranged in a soleplate 110 of the lower shell 16b. The slider 101 is rigid; it has the shape of an elongated beam extending between the lower shell 16b and the lower segment part 20b, and has a dovetailed cross-section for example. In another example (not illustrated), the cross-section of the slider is T-shaped or has any appropriate shape simultaneously allowing it to guide the radial translation of the lower segment part while preventing the axial movement thereof when it is subjected to a force having an axial component. The soleplate 110 is rigidly fastened to the lower shell 16b for example using fastening screws. More specifically, the soleplate 110 comprises an orifice 107 in which are arranged the pusher 108 and a return spring 109 that pushes the pusher axially outwards, the substantially rounded axially lower end 108′ of the pusher 108 protruding relative to the end of the soleplate 110. The axially lower surface 110′ of the soleplate 110 is provided with two cavities 112 and 114 situated on either side of the pusher 108. The slider 101 comprises a roller 105 mounted so that it is free to rotate about its central axis, the roller being situated at the axially outer end of the slider and interacting with the notches 112 and 114 during the radial movement of the lower segment part 20b. The soleplate 110 further comprises a stop 115 that allows the roller to be positioned in the notch 114 in a stable manner. The slider 101 is rigidly connected to the lower segment part 20b and is fastened thereto by means of a pin 116 inserted into an orifice 117, having an axis transverse to the longitudinal direction of the slider 101 and of the lower segment part 20b and to a fastening screw transverse to the axis of the orifice 117 (not shown).

In operation, the roller 105 of the slider 101 is positioned in the notch 112 when the mould is in the closed position. During the opening of the mould, the lower segment part 20b is moved radially outwards and the roller 105 of the slider 110 follows the movement of the segment and actuates the pusher 108 against the return spring 109. At the end of the radial retraction movement of the lower segment part 20b, the roller 105 arrives in the second notch 114 in which it is held by the protruding part 108′ of the pusher 108, which returns to its position under the effect of the spring 109, and by the stop 115.

The slider 110 adopts two stable positions when it moves: a first position corresponding to the closed position of the mould, when the roller 105 is positioned in the notch 112, and a second position corresponding to the open position of the mould, when the roller 105 is accommodated in the notch 114 of the soleplate 110 under the latch effect of the pusher 108. This makes it possible for the lower segment part 20b to be held in an axial and radial position and to prevent it from moving in the open position of the mould.

The operation of the mould according to the first embodiment will now be described with reference to FIGS. 3a to 3i. FIG. 3a illustrates the curing mould 10 in the closed or curing position for obtaining a tyre P, the roller 105 being situated in the notch 112 of the soleplate 110. FIG. 3b illustrates the step of starting to open the mould when a force is exerted in an axial direction on the conical ring 14, which causes the radial retraction of the upper and lower segment parts simultaneously. A device (not shown), for example such as a finger protruding on the upper segment part 20a that interacts with an orifice in the lower segment part 20b at the interface of said parts, makes it possible to synchronize the upper 20a and lower 20b parts of each segment. The roller 105 has left the notch 112. Once the radial retraction of the segments has taken place, the upper segment parts 20a are separated from the lower segment parts 20b along the radial plane M.

FIG. 3c illustrates the fully open position of the mould, in which position the upper moulding part is moved away axially so that the cured tyre can be removed. In this position, the roller 105 interacts with the notch 114 of the soleplate 110 and holds the lower segment part 20b in position.

FIGS. 3d and 3e illustrate steps of closing the empty mould. The mould is closed by axially lowering the upper plate 2 and the conical ring 14.

FIG. 3f illustrates a step of opening the mould, but only axially (or vertically), without the radial retraction of the segments, in particular the upper 20a and lower 20b segment parts. The lower segment parts 20b are held against the lower shell 16b due to the force of the spring 109 of the pusher 108, which applies a force to the roller 105 of the slider 101. The actuator for moving the upper segment parts 20a holds them against the upper shell 16a. A new green tyre E can be inserted into the mould cavity, as shown in FIG. 3g. The mould is then closed axially (or vertically) only, as illustrated in FIG. 3h, and curing can take place when the mould is fully closed, as illustrated in FIG. 3i.

This additional step of closing the empty mould before it is opened axially (or vertically) only makes it possible to return the upper segment parts and the lower segment parts to their radial positions before the insertion of a new green tyre and thus prevent the pinching of the rubber at the interfaces between the radially outer end of each upper part 20a and lower part 20b respectively and the upper shell 16a and lower shell 16b respectively. The appearance of the cured tyre is thus improved.

In a second embodiment, which can be seen most clearly in FIGS. 4, 5a, 5b and 6, all the elements of the holding device 100 also belong to the lower segment part 20b and to the lower shell 16b. More specifically, the holding device 100 comprises a slider 121 comprising two notches 124 and 126 that interact with a pusher 103 belonging to the lower segment part 20b. The slider 121 is rigidly fastened by its radially outer end 121′ to the lower shell 16b by any appropriate means, for example using a screw fastening (not illustrated), the other end of the slider being free. The slider 121 is rigid; it has the shape of an elongated beam extending between the lower shell 16b and the lower segment part 20b, and has a cross-section in the shape of a dovetail for example. The lower segment part 20b comprises at its base an elongated orifice 122 the shape of which complements the shape of the slider 121; more specifically, it has a cross-section in the same shape as the slider, in the shape of a dovetail in the example illustrated in the figures, but with larger dimensions in order to allow the lower segment part 20b to slide radially relative to the slider 121. The lower segment part 20b comprises a pusher 103 of the type comprising a ball 118 pushed downwards by a return spring 119.

In operation, the ball 118 of the pusher 103 is positioned in the notch 124 when the mould is in the closed position. During the opening of the mould, the lower segment part 20b is moved radially outwards and the ball 118 of the pusher 103 follows the movement of the segment by rolling on the slider 121 while compressing the return spring 119. At the end of the radial retraction movement of the lower segment part 20b, the ball 118 of the pusher 103 arrives in the second notch 126, in which it is held under the effect of the return spring 119, which expands. A stop 128 prevents any radial movement of the lower segment part 20b beyond this position.

The lower segment part 20b adopts two stable positions when it moves: a first position corresponding to the closed position of the mould, when the pusher 103 is positioned in the notch 124, and a second position corresponding to the open position of the mould, when the pusher 103 is accommodated in the notch 126 of the slider 121 by a latch effect. This makes it possible for the lower segment part 20b to be held in an axial and radial position and to prevent it from moving in the open position of the mould.

The operation of the mould according to the second embodiment of the invention will now be described with reference to FIGS. 7a to 7i. FIG. 7a illustrates the curing mould 10 in the closed or curing position for obtaining a tyre P, the ball 118 of the pusher 103 being situated in the notch 124 of the slider 121. FIG. 7b illustrates the step of starting to open the mould when a force is exerted in an axial direction on the conical ring 14, which causes the radial retraction of the upper and lower segment parts simultaneously. A device (not shown), for example such as a finger protruding on the upper segment part 20a that interacts with an orifice in the lower segment part 20b at the interface of said parts, makes it possible to synchronize the upper 20a and lower 20b parts of each segment. The ball 118 of the pusher 103 has left the notch 124. Once the radial retraction of the segments has taken place, the upper segment parts 20a are separated from the lower segment parts 20b along the radial plane M.

FIG. 7c illustrates the fully open position of the mould, in which position the upper moulding part is moved away axially so that the cured tyre can be removed. In this position, the ball 118 of the pusher 103 interacts with the notch 126 of the slider 121 and holds the lower segment part 20b in position.

FIGS. 7d and 7e illustrate steps of closing the empty mould. The mould is closed by axially lowering the upper plate 2 and the conical ring 14.

FIG. 7f illustrates a step of opening the mould, but only axially (or vertically), without the radial retraction of the segments, in particular the upper 20a and lower 20b segment parts. The lower segment parts 20b are held against the lower shell 16b due to the force of the spring 119 of the pusher 103, which presses the ball into the notch of the slider 121. The actuator for moving the upper segment parts 20a holds them against the upper shell 16a. A new green tyre E can be inserted into the mould cavity, as shown in FIG. 7g. The mould is then closed axially (or vertically) only, as illustrated in FIG. 7h, and curing can take place when the mould is fully closed, as illustrated in FIG. 7i.

As explained above, this additional step of closing the empty mould before it is opened axially (or vertically) only makes it possible to return the upper segment parts and the lower segment parts to their radial positions before the insertion of a new green tyre and thus prevent the pinching of the rubber at the interfaces between the radially outer end of each upper part 20a and lower part 20b respectively and the upper shell 16a and lower shell 16b respectively. This makes it possible to avoid the appearance of burrs on the cured tyre.

Other variants and embodiments of the invention can be envisaged within the scope of the invention as claimed. The upper segment part and the lower segment part can thus be separated axially along a radial plane other than the median plane or along a plane that is not radial.

1.-13. (canceled)

14. A mold for curing a tire, comprising:
an upper shell for molding a tire sidewall;
a lower shell for molding the tire sidewall; and
a crown ring of circumferential segments for molding a tire tread, each segment comprising an upper segment part suitable for being axially separated from a lower segment part,
wherein the mold is suitable for interacting with means for actuating a radial movement of all of the segment parts simultaneously and an axial movement of the upper part of each segment relative to the lower part of a same segment during operations to open and close the mold, and
wherein each lower segment part comprises a holding device for holding the lower segment part in a radial position between a closed position of the mold and an open position thereof, the elements of the holding device belonging to the lower segment part and to the lower shell.

15. The mold according to claim 14, wherein the holding device is produced so as to make it possible to hold the lower segment part in an axial position.

16. The mold according to claim 14, wherein the holding device comprises a slider extending in a radial direction that interacts with a pusher produced so as to exert an axial force on the slider during the radial movement of the lower segment part.

17. The mold according to claim 16, wherein the slider is capable of moving with the lower segment part and the pusher is fixed on the lower shell by means of a soleplate.

18. The mold according to claim 17, wherein the slider comprises a roller that interacts with two notches arranged on either side of the pusher in the soleplate during the radial movement of the lower segment part.

19. The mold according to claim 16, wherein the slider is fixed on the lower shell and the pusher is capable of moving with the lower segment part.

20. The mold according to claim 19, wherein the slider comprises two notches that interact with a ball of the pusher during the radial movement of the lower segment part.

21. The mold according to claim 16, wherein the pusher comprises a return spring.

22. The mold according to claim 21, wherein the return spring can be calibrated so that it is able to hold the lower segment part in a predefined position when force exerted on the pusher is less than force that the pusher undergoes when the mold is closed.

23. The mold according to claim 16, wherein the slider has a cross-section in a shape of a dovetail.

24. A method for molding a green tire using a curing mold,
the curing mold comprising:
an upper shell for molding a tire sidewall;
a lower shell for molding the tire sidewall; and
a crown ring of circumferential segments for molding a tire tread, each segment comprising an upper segment part suitable for being axially separated from a lower segment part,
wherein the curing mold is suitable for interacting with means for actuating a radial movement of all of the segment parts simultaneously and an axial movement of the upper part of each segment relative to the lower part of a same segment during operations to open and close the mold, and
the method comprising:
a step of removing the tire at an end of curing when all of the segments are simultaneously moved radially outwards and when the upper part of each segment is moved axially upwards, the lower part of the segment being caused to switch from a first radially inner holding position to a second radially outer holding position.

25. The molding method according to claim 24 further comprising a step of closing an empty mold followed by a step of opening the mold without radial retraction of the segments in order to insert a new green tire into the mold.

26. The molding method according to claim 25, wherein the mold is closed axially only on the green tire inserted into the mold.
